(19) United States
(12) Patent Application Publication
(10) Pub. No.: US 2015/0046186 A1
(43) Pub. Date: Feb. 12, 2015

(54) METHOD AND SYSTEM FOR MANAGING THE INFORMATION RELATED TO DISCHARGE OF PATIENTS

(71) Applicant: Sign Out Now, LLC, Glendora, CA (US)

(72) Inventor: Mark Brian Zimmerman, Boca Raton, FL (US)

(21) Appl. No.: 14/452,538

(22) Filed: Aug. 6, 2014

Related U.S. Application Data
(60) Provisional application No. 61/864,089, filed on Aug. 9, 2013.

(51) Int. Cl. G06F 19/00

(52) U.S. Cl. CPC G06F 19/322
USPC 705/3

(57) ABSTRACT

A computer implemented system for transferring information by healthcare professionals to primary care physicians related to the discharge of patients, transition of care and patient handoff. The computer implemented system includes a database comprising one or more directories for storing instructions related to details of healthcare professionals, patients and primary care physicians, a processing unit coupled to the database and executes the stored information, a registration module, a patient module, a primary care physician module and a share module. The registration module creates registered profiles of healthcare professionals by receiving the credentials. The patient module receives details of the patient's medical history and the patient's discharge information from healthcare professionals. The primary care physician module selects primary care physicians from a directory by the healthcare professionals. The share module shares detail stored in the patient module with selected primary care physicians, the selected primary care physician gets access to the shared information only on verifying the credentials through the registration module.

### CROSS-REFERENCE TO RELATED APPLICATION

This application claims priority to a U.S. Provisional Application No. 61/864,089 filed on Aug. 9, 2013, the entire content of which is incorporated herein by references in its entirety.

### BACKGROUND OF THE INVENTION

1. Field of the Invention

The present invention generally relates to managing of information related to discharge of patients and more particularly relates to a system and a method for sending patient's discharge notice by a healthcare professional to a primary care physician.

2. Description of Related Art

The healthcare system is growing in terms of complexity and level of sophistication in regards to the quality of care being administered to patients. Various software are known to help the healthcare professionals for managing the information related to patients. Optimizing the efficiency and effectiveness of information sharing in many fields of endeavor often requires a significant amount of coordination and complex interaction between multiple entities.

For example, when patients are admitted to a hospital for care, it is the responsibility of the hospital physician to look after the details regarding the patient such as patient's diagnosis and the treatments administered etc. After the patient is released and discharged from the care of the hospital, it is the responsibility of the patient's primary care physician to look after the details regarding the patient such as patient's medical history, the treatments received etc. This is known as the “boundary of care” and the “patient handoff” between healthcare professionals. Often times, the patient is unfortunately readmitted to the hospital within 30 days of original discharge due to the lack of follow-up and continued care of a patient when discharged from an emergency hospital treatment. With the absence of a standard, universal patient handoff procedure, healthcare communication for the patient's follow-up care is less accessible, and the patient may not fully recover from the initial health issue.

Typically, once the healthcare professional has treated a patient, the healthcare professional should notify the patient's primary care physician about the treatment and the discharge release of a patient to help provide the most effective care. This is essentially a patient handoff of medical responsibility between healthcare professionals. Unfortunately, there is no universally standard procedure, follow-up, or tracking of the handoff, thus making accountability difficult and patient care will suffer with the lack of discharge information being communicated. Therefore, there is a need of a method and a system for managing the information related to the discharge of patients.

### SUMMARY OF THE INVENTION

In accordance with the teachings of the present invention, a method and a system for transferring information by one or more healthcare professionals to one or more primary care physicians related to the discharge of one or more patients is provided.

An object of the present invention is to provide a system for transferring information by one or more healthcare professionals to one or more primary care physicians related to the discharge of one or more patients. The computer implemented system includes at least one database and a processing unit coupled to the database. The database further includes one or more directories such as a first directory, a second directory and a third directory. The first directory for storing one or more instructions related to details of healthcare professionals, the second directory for storing one or more instructions related to details of patients; and the third directory for storing one or more instructions related to details of primary care physicians.

The processing unit includes a registration module for creating registered profiles of healthcare professionals by receiving credentials and further the registration module stores the registered profiles in the first directory, a patient module to receive details of the patient's medical history, current treatment and the patient discharge information from one or more healthcare professionals and further the patient module stores the patient's medical history, current treatment and the discharge information in the second directory, a primary care physician module to select one or more primary care physicians from third directory by one or more healthcare professionals, and a share module to share details from patient module with selected one or more primary care physicians. Further, wherein the primary care physician verified the credentials on the database to access the details shared from patient module.

Another object of the present invention is to provide an edit profile module within the registration module for editing the credentials of the registered healthcare professional. The processing unit further includes a staff module to add one or more healthcare staff members to the registration module.

Another object of the present invention is to provide a system with the processing unit including an office module to add one or more office details to the registration module. Further, the patient module includes a multimedia module for receiving multimedia data related to patient's medical history.

Another object of the present invention is to provide a system with primary care physician module to display a list of primary care physicians stored in the third directory on receiving inputs from the one or more healthcare professionals. Further, the processing unit includes a dashboard module to display status of each shared patient's medical history and discharge status with one or more primary care physicians.

Another object of the present invention is to provide a system with the processing unit further including a notification module to send notifications of status of the patient's discharge notices from the dashboard to the healthcare professional.

These and other objects, features and advantages of the invention will become more fully apparent in the following detailed description, taken in conjunction with the accompanying drawings.

### BRIEF DESCRIPTION OF DRAWINGS

The disclosure will provide details in the following description of preferred embodiments with reference to the following figures wherein:

FIG. 1 illustrates a block diagram of a computer implemented system for transferring information by one or more healthcare professionals to one or more primary care physicians in accordance with a preferred embodiment of the present invention;

FIG. 2A is a screenshot showing, by way of an example, a UI of a registration module for registration of healthcare professionals in accordance with an exemplary embodiment of the present invention;

FIG. 2B is a screenshot showing, by way of an example, another UI of a registration module for registration of healthcare professionals in accordance with another exemplary embodiment of the present invention;

FIG. 2C is a screenshot showing, by way of an example, a UI of an edit profile module, an office module and a staff module in accordance with another exemplary embodiment of the present invention;

FIG. 3A is a screenshot showing, by way of an example, a UI of primary care physician module in accordance with an exemplary embodiment of the present invention;

FIG. 3B is a screenshot showing, by way of an example, another UI of primary care physician module in accordance with another exemplary embodiment of the present invention;

FIG. 4A is a screenshot showing, by way of an example, a UI of patient's module in accordance with an exemplary embodiment of the present invention;

FIG. 4B is a screenshot showing, by way of an example, a UI of a multimedia module and a share module in accordance with an exemplary embodiment of the present invention;

FIG. 5 is a screenshot showing, by way of an example, a UI of dashboard module for displaying status of each shared patient's medical history and patient discharge status for the one or more healthcare professionals in accordance with a preferred embodiment of the present invention; and

FIG. 6 is a flowchart of a method for transferring information by one or more healthcare professionals to one or more primary care physicians related to the discharge of one or more patients.

### DETAILED DESCRIPTION OF DRAWINGS

While this technology is illustrated and described in a preferred embodiment, a method and a system for managing the information related to discharge of patients may be produced by many different processes, configurations and computer languages. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the technology described herein.

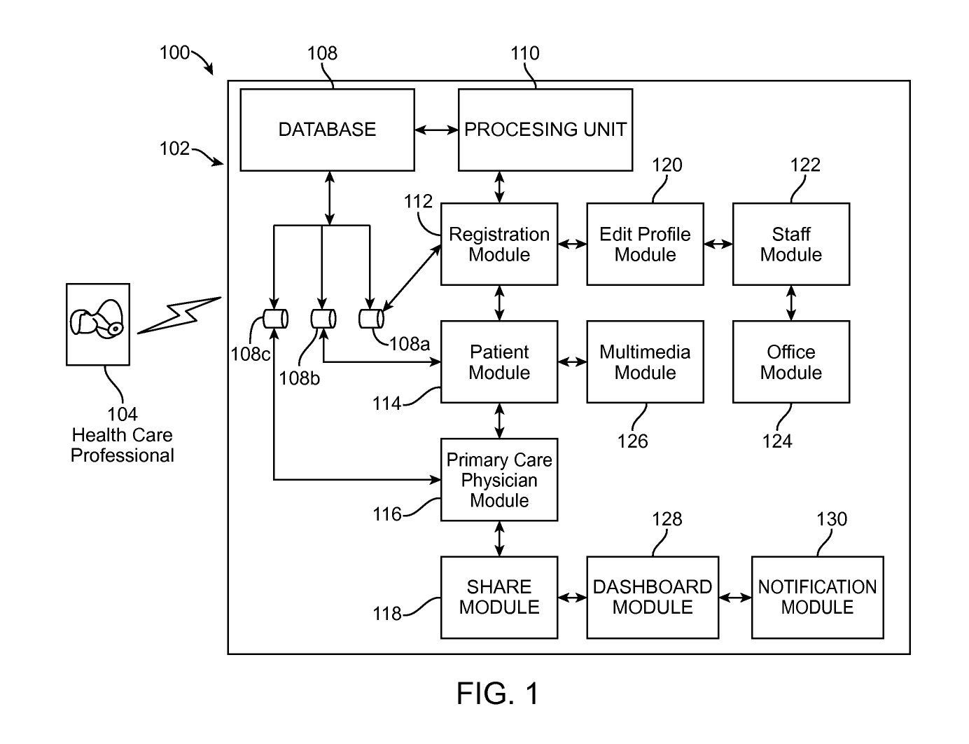

FIG. 1 illustrates a block diagram 100 of a computer implemented system 102 for transferring information by one or more healthcare professionals 104 to one or more primary care physicians 106 related to the discharge of one or more patients. The computer implemented system 102 includes at least one database 108 and a processing unit 110. The database 108 includes one or more directories such as a first directory 108a for storing one or more instructions related to details of the healthcare professional 104, a second directory 108b for storing one or more instructions related to details of the patients and a third directory 108c for storing one or more instructions related to details of the primary care physician 106. The processing unit 110 is coupled to the database 108 for executing the stored instructions.

In a preferred embodiment of the present invention, the processing unit 110 includes a registration module 112 for creating registered profiles of healthcare professionals by receiving credentials and storing the details in the first directory 108a, a patient module 114 to receive details of the patient's medical history and the patient discharge information from the one or more healthcare professional 104 and storing the details in the second directory 108b, a primary care physician module 116 for selecting the one or more primary care physician 106 from the third directory 108c by the one or more healthcare professionals 104, and a share module 118 to share details stored in the patient module 114 with the selected one or more primary care physicians 106. The primary care physician 106 verifies the credentials on the registration module 112 to access the shared details in said patient module 114.

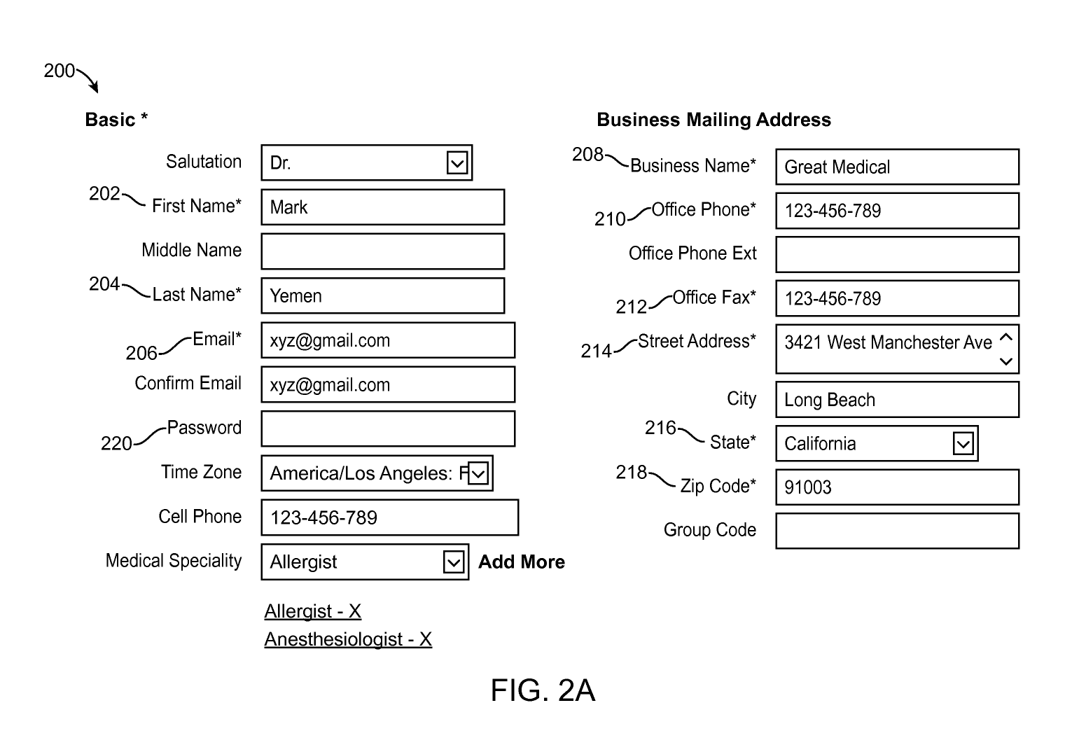

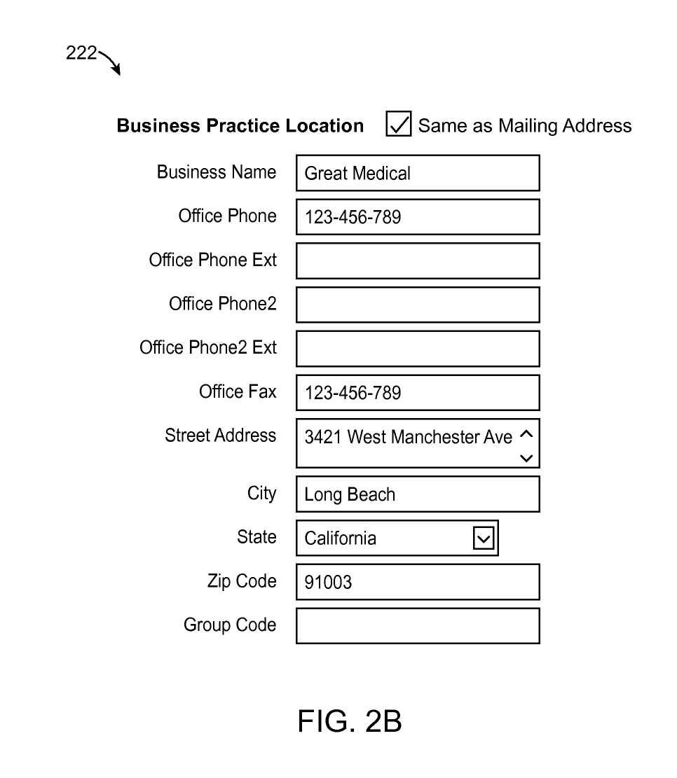

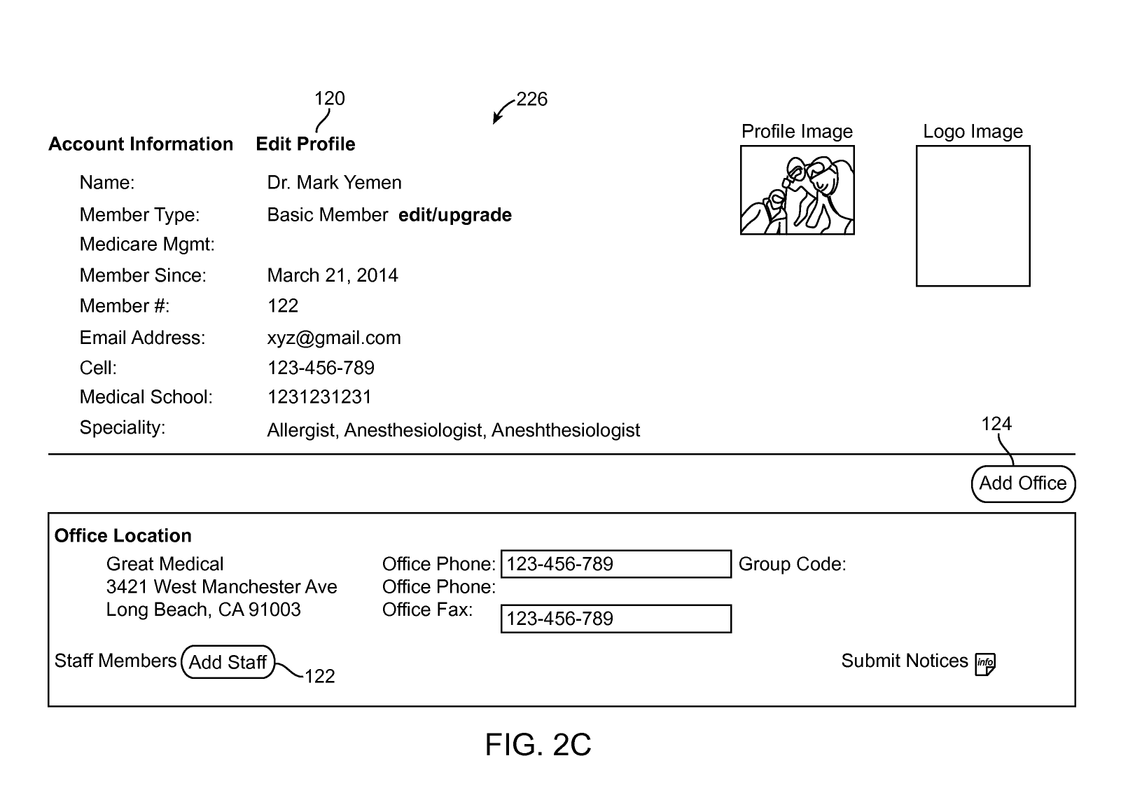

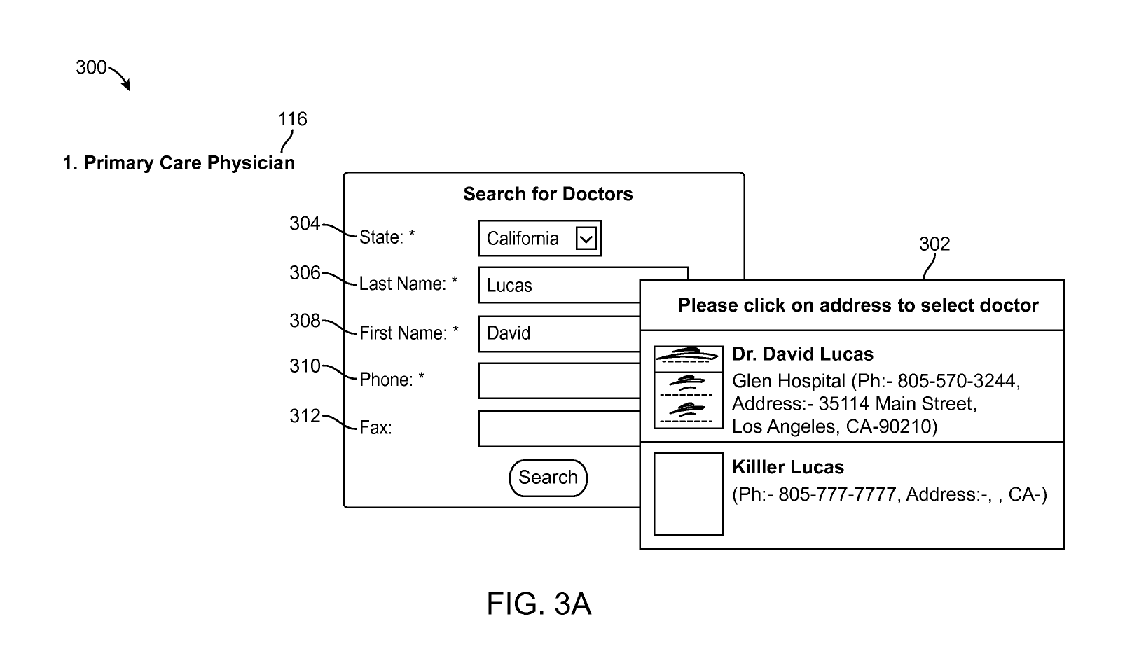

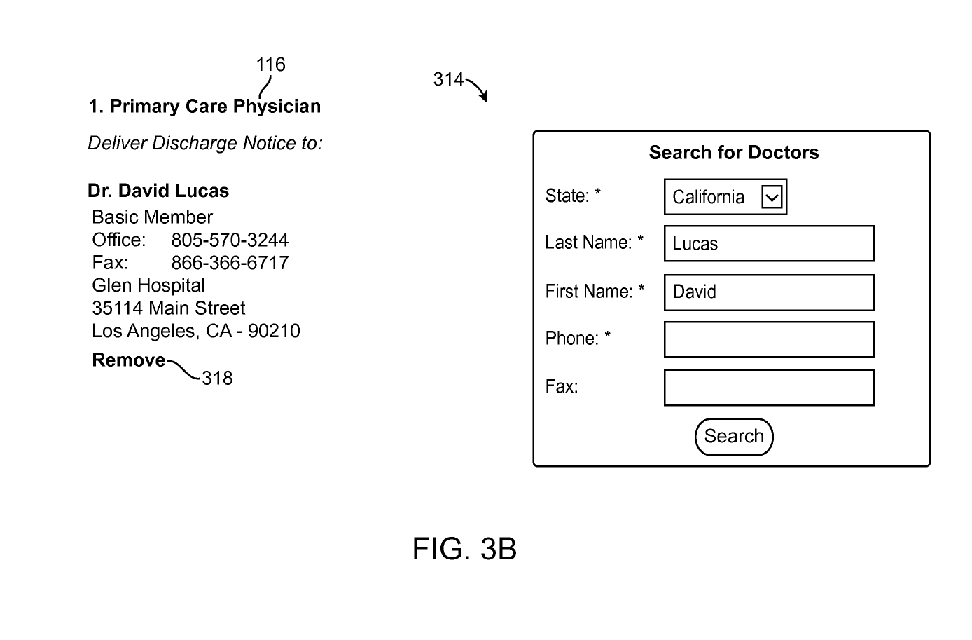

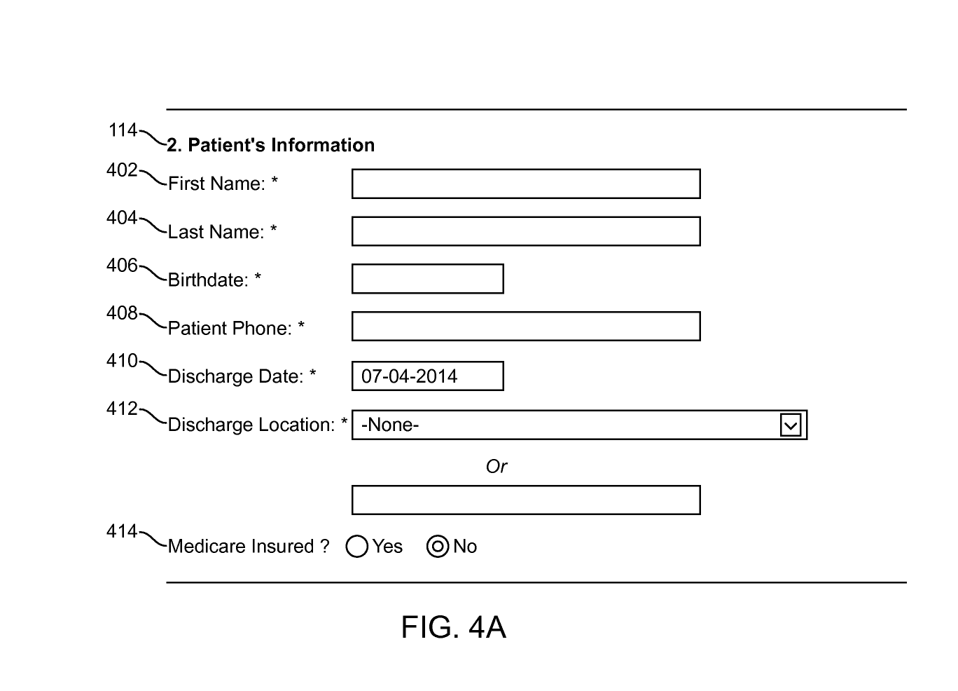

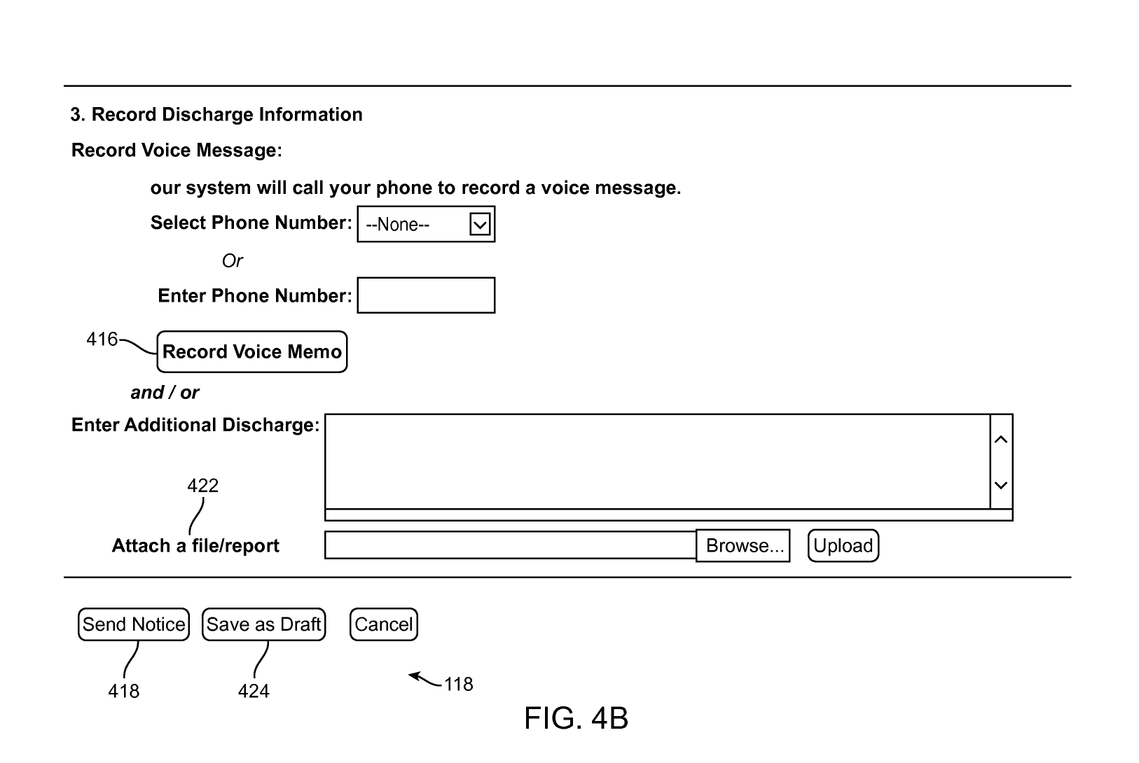

The registration module 112, the primary care physician module 116, the patient module 114 and the share module 118 are explained in detail in conjunction FIG. 2A to FIG. 2B, FIG. 3A to FIG. 3B, FIG. 4A and FIG. 4B respectively. In another preferred embodiment of the present invention, the registration module 112 further includes an edit profile module 120 for editing the credentials of the healthcare professional 104.

In another preferred embodiment of the present invention, the processing unit 110 further includes a staff module 122 to add one or more healthcare staff members to the registration module 112 and an office module 124 to add one or more office details to the registration module 112. The edit profile module 120, the staff module 122 and the office module 124 is explained in detail in conjunction with FIG. 2C of the present invention.

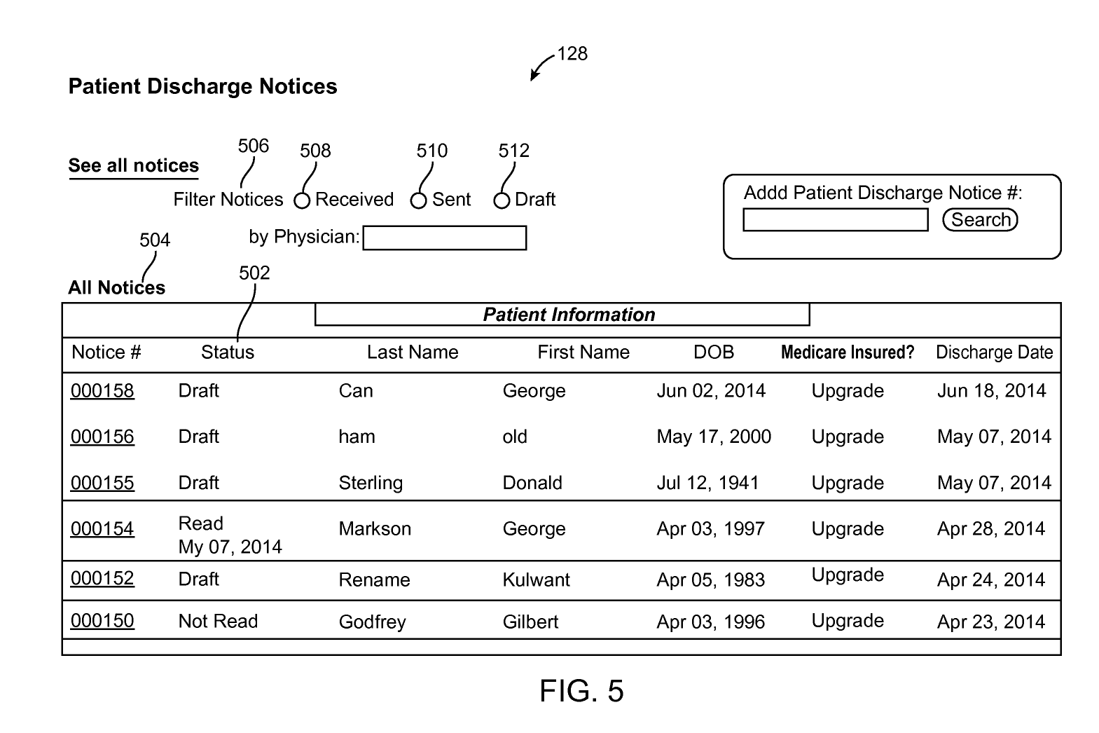

In another preferred embodiment of the present invention, the patient module 114 further includes a multimedia module 126 for receiving multimedia data related to patient's medical history. Further, in another embodiment of the present invention, the processing unit 110 further includes a dashboard module 128 to display status of each shared patient's medical history and patient discharge status with one or more primary care physicians 106. The multimedia module 126 and the dashboard module 128 are explained in detail in conjunction with FIG. 4B and FIG. 5 respectively of the present invention.

In another preferred embodiment of the present invention, the processing unit 110 further includes a notification module 130 to send notifications of status of the patient's discharge notices from the dashboard module 128 to the healthcare professional 104. Examples of notifications include but not limited to SMS, MMS, FAX and Email etc. The notification module 130 is explained in detail in conjunction with FIG. 5 of the present invention.

FIG. 2A is a screenshot showing, by way of an example, a UI 200 of a registration module for registration of healthcare professionals in accordance with an exemplary embodiment of the present invention. In a preferred embodiment of the present invention, the healthcare professional registers on the registration module by providing credentials such as First Name 202, Last Name 204, Email 206, and password 220.

Further, the healthcare professional registers the business mailing address by providing details such as Business Name 208, Office Phone 210, Office Fax 212, Street Address 214, State 216, and Zip Code 218. Further, in another embodiment of the present invention examples of the credentials may include but not limited to details such as middle name, confirm email, medical specialty, cell phone, time zone and city.

FIG. 2B a screenshot showing, by way of an example, another UI 222 of a registration module for registration of healthcare professionals in accordance with another exemplary embodiment of the present invention. The healthcare professional further provides details of one or more business practice locations. In a preferred embodiment of the present invention, the business mailing address is similar to the business practice location. However, it would be readily apparent to those skilled in the art that the business practice location may be dissimilar to the business mailing location without deviating from the scope of the present invention.

FIG. 2C is a screenshot showing, by way of an example, a UI 226 of an edit profile module 120, a staff module 122 and an office module 124 in accordance with another exemplary embodiment of the present invention. The edit profile 120 facilitates the healthcare professional for editing the credentials provided for registering the profile in the first directory.

The office module 124 allows the healthcare professional to change the address and other details of business practice locations. Further, the staff module 122 allows adding of one or more healthcare staff members to the registration module. In another embodiment of the present invention, the healthcare staff members may be saved in one or more directories such as a fourth directory. Examples of the healthcare staff members include but not limited to nurses, lab attendants, office managers, medical trainees etc.

FIG. 3A is a screenshot showing, by way of an example, a UI 300 of primary care physician module 116 in accordance with an exemplary embodiment of the present invention. In a preferred embodiment of the present invention, the primary care physician module 116 displays a list 302 of primary care physicians stored in the third directory on receiving inputs from the one or more healthcare professionals.

Examples of inputs include but not limited to State 304, Last Name 306, First Name 308, Phone 310 and Fax 312. It would be readily apparent to those skilled in the art that various inputs may be envisioned to extract the list of doctors without deviating from the scope of the present invention. For exemplary purposes as shown in FIG. 3A, on receiving input ‘Luc’ in Last Name 306 displays a list 302 of primary care physicians by the name of Dr. David Lucas and Killer Lucas etc.

FIG. 3B is a screenshot showing, by way of an example, another UI 314 of primary care physician module 116 in accordance with another exemplary embodiment of the present invention. The primary care physician module 116 displays the details of the selected primary care physicians. The details include but not limited to Name, office number, fax number, hospital name, address etc. Further, the primary care physician module 116 provides a remove tab 318 for removing the selected primary care physician.

FIG. 4A is a screenshot showing, by way of an example, a UI 400 of patient's module 114 in accordance with an exemplary embodiment of the present invention. The patient's module 114 receives detail of the patient's medical history and the patient discharge information from the one or more healthcare professionals. Examples of patient's medical history details include but not limited to First Name 402, Last Name 404, Birthdate 406, Patient Phone 408, Discharge Date 410, Discharge Location 412, and Medicare insured 414.

FIG. 4B is a screenshot showing, by way of an example, a UI of patient module 114, multimedia module 416 and share module 118 in accordance with another exemplary embodiment of the present invention. The patient module 114 further includes a multimedia module 416 for receiving multimedia data related to patient's medical history. In a preferred embodiment of the present invention, the multimedia module 416 allows the healthcare professional to input a phone number for recording a voice memo related to the patients discharge information.

Further, the patient module 114 allows the healthcare professional to enter additional discharge information 420 related to the patient. Furthermore, the healthcare professional allows the patient module 114 to attach a file/report 422 related to the patient's discharge information.

The share module 118 displays a send notice tab 418 for sharing the information stored in the patient's module 114 with the selected primary healthcare physician. In a preferred embodiment of the present invention, the information is shared by email with the primary healthcare professional. In order to access the information shared, the primary care physician verify the credentials on the registration module to access the shared details in the patient module. In case, the primary care physician is not registered on the database, then the primary care physician creates a profile on the database and then verifies details to access the shared details in the patient module.

Example of information shared through email includes ‘A Patient Discharge Notice has been sent to you though the system. To review your patient's information, please sign-in to your account below. http://signoutnow.com.

Patient: Kelly K. Discharge Date: Jul. 19, 1990

Glen Hospital 35114 Main Street, Los Angeles, Calif. 90210.’

However, it will be readily apparent to those skilled in the art may envision various methods of sharing such as Fax, postal mail, SMS and messages without deviating from the scope of the present invention. Further, the share module 118 includes a save as draft tab 424 for storing patient discharge information in the dashboard module 128. The dashboard module 128 is explained in detailed in conjunction with FIG. 5 of the present invention.

FIG. 5 is a screenshot showing, by way of an example, a UI 500 of dashboard module 128 for displaying status of each shared patient's medical history and patient discharge status for the one of more healthcare professionals. The dashboard module 128 displays the status 502 list of all notices 504 saved as drafts in by healthcare professional or shared with the primary care physician.

Examples of the status include but not limited to draft, read, sent or not read. ‘Draft’ shows the discharge notices being saved for later operations. ‘Read’ shows the discharge notices being read by the healthcare professional. ‘Not read’ shows the discharge notice that is not yet read by the healthcare professional. Further, the dashboard module 128 allows the healthcare professional to filter notices 506 by selecting any of the received tab 508, sent tab 510, and draft tab 512.

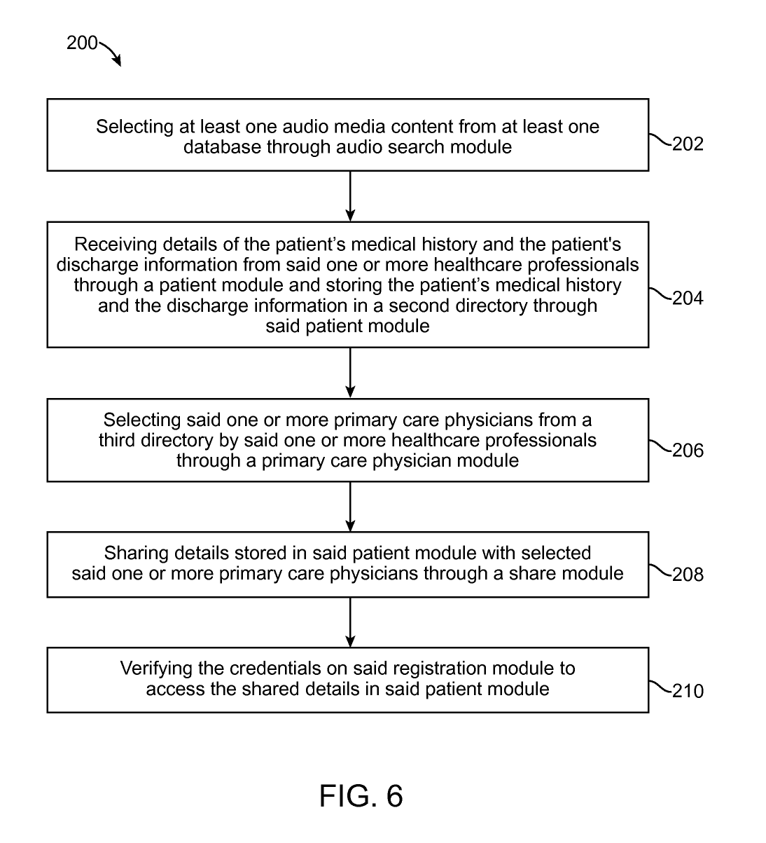

FIG. 6 is a flowchart of a method 600 for transferring information by one or more healthcare professionals to one or more primary care physicians related to the discharge of one or more patients. The method 600 initiates with a step 602 of creating registered profiles of one or more healthcare professionals by receiving credentials in a registration module and storing the registered profiles in a first directory. The step 602 is explained in detail in conjunction with FIG. 2A and FIG. 2B of the present invention.

The step 602 is followed by a step 604 of receiving details of the patient's medical history and the patient discharge information from one or more healthcare professionals through a patient module and storing in a second directory. The step 604 is explained in detail in conjunction with FIG. 4A and FIG. 4B of the present invention.

The step 604 is then followed by a step 606 of selecting one or more primary care physicians from a third directory by one or more healthcare professionals through a primary care physician module. The step 606 is explained in detail in conjunction with FIG. 3A and FIG. 3B of the present invention.

The step 606 is then followed by a step 608 of sharing details stored in patient module with selected one or more primary care physicians through a share module. The step 608 is explained in detail in conjunction with FIG. 4B of the present invention. Examples of healthcare professionals and primary care physician include but not limited to doctors, surgeons, medical assistants, office managers, nurses, liver surgeons, brain surgeons, consultants and specialists etc.

The step 608 is then followed by a step 610 of registering on the registration module by the one or more primary care physicians to access shared details in the patient module. The step 610 is explained in detail in conjunction with FIG. 2A and 2B of the present invention. In another embodiment of the present invention, the primary care physician is already registered to get direct access to the stored information in the patient module.

The present invention offers various advantages such as a universal platform for the doctors to send and receive patients discharge notices while providing accountability by tracking the delivery of such patient discharge notices. The present invention requires minimum input of details for preparing the patient discharge notice to effectively provide essential patient information communication between the healthcare professionals involved the discharge. This mitigates risk in the greatest hazard area known as the “boundary of care” when handing-off a patient's care responsibilities to another physician.

The foregoing discussion discloses and describes merely exemplary embodiments of the present invention. One skilled in the art will readily recognize from such discussion and from the accompanying drawings that various changes, modifications and variations can be made therein without departing from the spirit and scope of the invention.

1: A computer implemented system for transferring information by one or more healthcare professionals to one or more primary care physicians related to the discharge of one or more patients, the computer implemented system comprising:
at least one database comprising one or more directories, wherein at least a first directory for storing one or more instructions related to details of said healthcare professionals, at least a second directory for storing one or more instructions related to details of said patients; and at least a third directory for storing one or more instructions related to details of said primary care physicians; and
a processing unit coupled to said database for executing the stored instructions, the processing unit comprising:
a registration module for creating registered profiles of healthcare professionals by receiving credentials and further said registration module stores the registered profiles in said first directory;
a patient module to receive details of the patient's medical history and the patient discharge information from said one or more healthcare professionals and further said patient module stores the patient's medical history and the discharge information in said second directory;
a primary care physician module to select said one or more primary care physicians from said third directory by said one or more healthcare professionals; and
a share module to share details stored in said patient module with selected said one or more primary care physicians, wherein said one or more primary care physicians verify the credentials on said registration module to access the shared details in said patient module.

2. The computer implemented system of claim 1 wherein said registration module further comprising an edit profile module for editing the credentials of said healthcare professional.

3. The computer implemented system of claim 1 wherein said processing unit further comprising a staff module to add one or more healthcare staff members to said registration module.

4. The computer implemented system of claim 1 wherein said processing unit further comprising an office module to add one or more office details to said registration module.

5. The computer implemented system of claim 1 wherein said primary care physician module displays a list of primary care physicians stored in said third directory on receiving inputs from said one or more healthcare professionals.

6. The computer implemented system of claim 1 wherein said patient module further comprising a multimedia module for receiving multimedia data related to patient's medical history.

7. The computer implemented system of claim 1 wherein said processing unit further comprising a dashboard module to display status of each shared patient's medical history and patient's discharge status for said one or more healthcare professionals.

8. The computer implemented system of claim 7 wherein said processing unit further comprising a notification module to send notifications of status of the patient's discharge notices from said dashboard module to said one or more healthcare professionals.

9. The computer implemented system of claim 1 wherein said registration module further receives credentials to store details of one or more primary care physicians in said database.

10. A non-transitory computer readable storage medium having instructions for a database system stored there on that, when executed by a processing unit, cause the processing unit to perform a method comprising steps of:
creating registered profiles of healthcare professionals by receiving credentials in a registration module and storing the registered profiles in a first directory through said registration module;
receiving details of the patient's medical history and the patient's discharge information from said one or more healthcare professionals through a patient module and storing the patient's medical history and the discharge information in a second directory through said patient module;
selecting said one or more primary care physicians from a third directory by said one or more healthcare professionals through a primary care physician module;
sharing details stored in said patient module with selected said one or more primary care physicians through a share module; and
verifying the credentials on said registration module to access the shared details in said patient module.

11. The method according to claim 10 further comprising the steps of editing the credentials of said healthcare professional through an edit profile module in said registration module.

12. The method according to claim 10 further comprising the steps of adding one or more healthcare staff members to said registration module through a staff module.

13. The method according to claim 10 further comprising the steps of adding one or more office details to said registration module through an office module.

14. The method according to claim 10 further comprising the steps of displaying a list of primary care physicians stored in a third directory on receiving inputs from said one or more healthcare professionals through a primary care physician module.

15. The method according to claim 10 further comprising the steps of receiving multimedia data related to patient's medical history through a multimedia module in said patient module.

16. The method according to claim 10 further comprising the steps of displaying status of each shared patient's medical history and patient's discharge status for said one or more healthcare professionals in said processing unit through a dashboard module.

17. The method according to claim 10 further comprising the step of sending notifications of status of the patient's discharge notices from said dashboard to said healthcare professional in said processing unit through a notification module.

18. The method according to claim 10 further comprising the step of receiving credentials to store details of one or more primary care physicians in said database through said registration module.
